(19) United States
(12) Patent Application Publication
(10) Pub. No.: US 2015/0121192 A1
(43) Pub. Date: Apr. 30, 2015

(54) DEBUGGING ERRORS IN DISPLAY OF WEB PAGES WITH PARTIAL PAGE REFRESH

(71) Applicant: Oracle International Corporation, Redwood Shores, CA (US)

(72) Inventors: Venkata Krishna Kishore Kondepudi, Foster City, CA (US); Siva Rajesh Chinni, Hyderabad (IN)

(73) Assignee: Oracle International Corporation, Redwood Shores, CA (US)

(21) Appl. No.: 14/061,766

(22) Filed: Oct. 24, 2013

(51) Int. Cl. G06F 17/22

(52) U.S. Cl. CPC G06F 17/2247
USPC 715/234

(57) ABSTRACT

An aspect of the present disclosure facilitates debugging of errors in display of web pages with partial page refresh capability. In an embodiment, a client system receives source code of a complete web page containing multiple elements, and captures in a log, a set of definitions present in the source code. The client system may display the complete web page based on the source code. As user interactions on the displayed web page cause partial page refreshes, the details of the corresponding requests and responses are added to the log. The user may then select a request of interest, and a formatted partial web page graphically representing the elements with changes due to the response corresponding to the selected request, is displayed.

### BACKGROUND OF THE DISCLOSURE

1. Technical Field

The present disclosure relates to display of web pages and more specifically to debugging of errors in display of web pages with partial page refresh.

2. Related Art

Web pages are often the basis for various user interfaces. Typically, each web page is defined/formed using languages such as Hypertext Markup Language (HTML) at server systems, and sent to client systems. Client systems have browser type software, which generates a user interface (display, playing audio/video, and receiving inputs, etc.) by rendering the web page from the page definition in HTML. The displayed web pages may be viewed as containing several elements (dropdown menus, text fields for user input, etc.), each having a corresponding definition in the web page definition.

Web pages are often displayed with partial page refresh capability. Such capability can be understood by comparison with web page displays without such a capability, wherein any submission from a displayed web page causes the entire page to be downloaded from a server and the entire page refreshed (re-displayed). In contrast, in case of partial page refresh capability, a page may be defined as several constituent parts, and only parts undergoing a change on submission may be refreshed while the remaining parts are left unchanged on the display, thereby providing a more user friendly experience.

Partial page refresh capability is usually complemented with asynchronous download capability also such that any updates to the web page definition occur in the background, without disrupting display of at least the other portions. The updates can be for any display elements in response to previously provided user inputs for other elements, according to the web page definition. Ajax is a commonly known technology provided along with browsers for such partial page refresh capability, as is well known in the relevant arts.

There is a general need to debug errors in display of web pages with partial page refresh. Debugging generally requires providing appropriate relevant information such that the users can identify the cause of any perceived issues.

### BRIEF DESCRIPTION OF THE DRAWINGS

Example embodiments of the present disclosure will be described with reference to the accompanying drawings briefly described below.

FIG. 1 is a block diagram illustrating an example environment (computing system) in which several aspects of the present disclosure can be implemented.

FIG. 2 is a flow chart illustrating the manner in which debugging of errors in display of pages with partial page refresh capability, is facilitated in one embodiment.

FIGS. 3A-3E depict user interface screens at corresponding successive time instances, to illustrate an example problem experienced by a user during partial page refreshes.

FIG. 4 depicts the requests for partial page requests and corresponding responses over a timeline.

FIG. 5A is a block diagram illustrating the details of a browser in an embodiment.

FIG. 5B is a block diagram illustrating the details of an analysis tool in an embodiment.

FIG. 5C depicts general format of HTML source code for a formatted partial web page.

FIG. 6A depicts web page interaction using a browser and requests-responses being captured by monitoring tool.

FIG. 6B depicts an example user interface for examining the HAR file.

FIGS. 7A-7C together depicts graphical user interface of analysis tool in runtime mode, showing formatted responses in graphic form.

FIG. 7D depicts the output of analysis tool in design-time mode, showing dependencies among elements of a web page.

FIG. 8A depicts the sample response data received for a partial page request.

FIG. 8B depicts HTML source code of a formatted partial web page for the sample response data.

FIG. 9 is a block diagram illustrating the details of a digital processing system in which several aspects of the present invention are operative by execution of appropriate software instructions.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

### 1. Overview

An aspect of the present disclosure facilitates debugging of errors in display of web pages with partial page refresh capability. In an embodiment, a client system receives source code of a complete web page containing multiple elements, and captures in a log, a set of definitions present in the source code. The client system may display the complete web page based on the source code. As user interactions on the displayed web page cause partial page refreshes, the details of the corresponding requests and responses are added to the log. The user may then select a request of interest, and a formatted partial web page, graphically representing the elements with changes due to the response corresponding to the selected request, is displayed.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

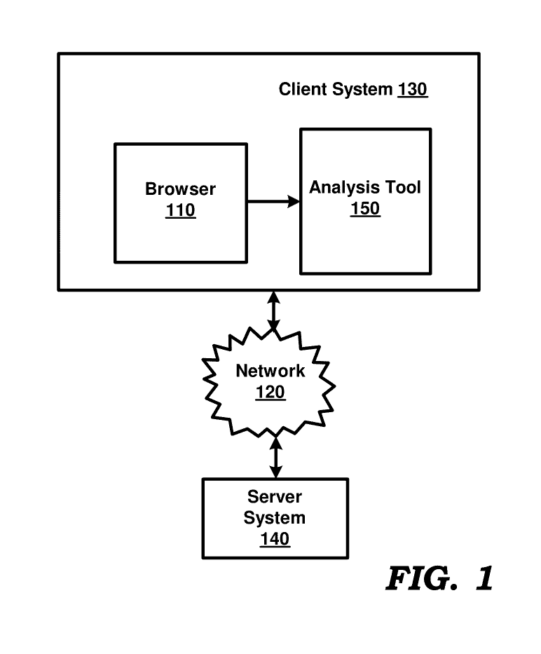

FIG. 1 is a block diagram illustrating an example environment (computing system) in which several aspects of the present disclosure can be implemented. The block diagram is shown containing network 120, client system 130, and server system 140. Client system 130 is in turn shown containing browser 110 and analysis tool 150. Each block of FIG. 1 is described below in further detail.

Merely for illustration, only representative number/type of systems is shown in FIG. 1. Many environments often contain many more systems, both in number and type, depending on the purpose for which the environment is designed. Each block of FIG. 1 is described below in further detail.

Network 120 provides connectivity between client system 130 and server system 140. Network 120 may be implemented using protocols such as Transmission Control Protocol (TCP) and/or Internet Protocol (IP), well known in the relevant arts. In general, in TCP/IP environments, a TCP/IP packet is used as a basic unit of transport, with the source address being set to the TCP/IP address assigned to the source system from which the packet originates and the destination address set to the TCP/IP address of the target system to which the packet is to be eventually delivered. An IP packet is said to be directed to a target system when the destination IP address of the packet is set to the IP address of the target system, such that the packet is eventually delivered to the target system by network 120.

Server system 140 serves web pages to various client systems over network 120. Thus, server system 140 receives requests, and provides the corresponding responses in the form of packets directed to client system 130. The requests can be for entire web pages, or information related to portions of previously served web pages, thereby supporting partial page refresh capability. Server system 140 may be implemented using various products such as Weblogic, Apache, Tomcat, etc., servers, available in the marketplace.

Client system 130 enables users to access web pages available via network 120, using browser 110. Browser 110 communicates with server system 140 using Hypertext Transfer Protocol (HTTP) type protocols. Browser 110 may correspond to software products such as Internet Explorer, Firefox, Chrome, etc., well known in the relevant arts. Browser 110 is implemented with partial page refresh capability (e.g., using Ajax technology, well known in the relevant arts). Analysis tool 150 provided according to aspects of the present disclosure enables debugging of errors when partial page refresh feature is operative, as described below in detail.

### 3. Debugging Facility

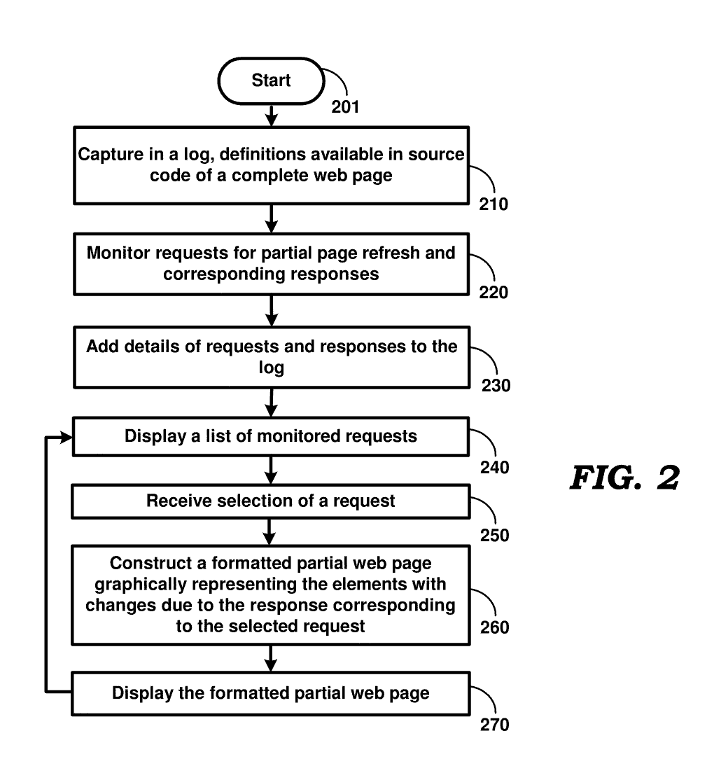

FIG. 2 is a flow chart illustrating the manner in which debugging of errors in display of pages with partial page refresh capability, is facilitated in one embodiment. The steps of the flowchart are described with respect to the specific systems of FIG. 1 merely for illustration. However, the features can be implemented in other systems and environments also without departing from the scope and spirit of several aspects of the present disclosure, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 201, in which control immediately passes to step 210.

In step 210, browser 110 captures in a log, definitions available in the source code of a complete web page. A web page is said to be complete when the corresponding definition contains all the portions required according to HTML so as to be suitable for rendering on a browser. The complete web page is normally received as an initial load to differentiate from the several further loads corresponding to partial page refreshes, noted below also. The captured definitions generally represent the information available only in the complete web page (and not in the responses for partial page refreshes), but is required to generate display information representing the changes due to responses corresponding to partial page refreshes, as described below. Examples of such definitions include client side logic (the processing or computations to be performed at the client side), style sheets (specifying the formatting information for the page/elements), etc. The log can be stored in a single memory unit or partitioned logically for storing in different memory units.

In step 220, browser 110 monitors requests for partial page refresh and corresponding responses, and adds details of requests and responses to the log in step 230. The requests (and responses) are contained in packets sent to (received from) network 120, and may be determined according to protocol conventions, as is well known in the relevant arts. In an embodiment described below, browser 110 is implemented with plug-ins, which monitor the packets and adds the relevant information in the log. The relevant information generally includes changes caused to the web page display (such as values for a field, formatting changes to specific portions of the web page being refreshed, etc.).

In step 240, analysis tool 150 displays a list of monitored requests. The list may be formed by examining the log generated in steps 210 and 220. In step 250, analysis tool 150 receives selection of one of the requests from the displayed list. Any suitable interface may be provided for enabling such selection.

In step 260, analysis tool 150 constructs a formatted partial web page graphically representing the elements with changes due to the response corresponding to the selected request. Such construction may imply that the elements are defined to be rendered in the same graphic form (presentation) as in which the responses of step 220 are rendered. Accordingly, the information captured in steps 210 and 220 in the log may be used for constructing the formatted partial web page.

In step 270, analysis tool 150 displays the formatted partial web page and control passes to step 240 for enabling the user to view responses for any other requests of interest. The graphical display of the elements provides a convenient user interface for users to easily identify/appreciate the changes. The loop of steps 240-270 may be continued to enable a user to graphically view the specific changes caused by the requests of interest.

Thus, by viewing the changes due to each response (for a corresponding request), the user may be able to debug any specific problems encountered due to partial refresh page requests. The description is continued with respect to an example problem and the manner in which such a problem can be debugged in accordance with the features described above.

### 4. Example Problem

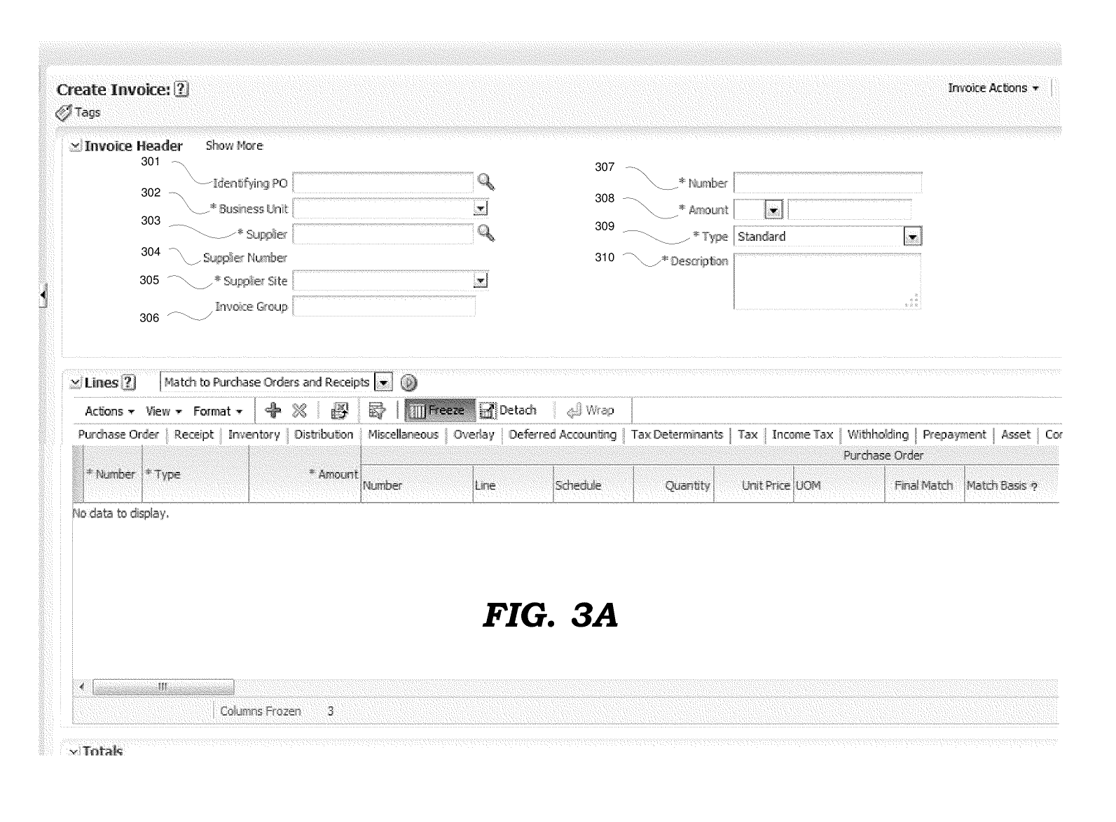

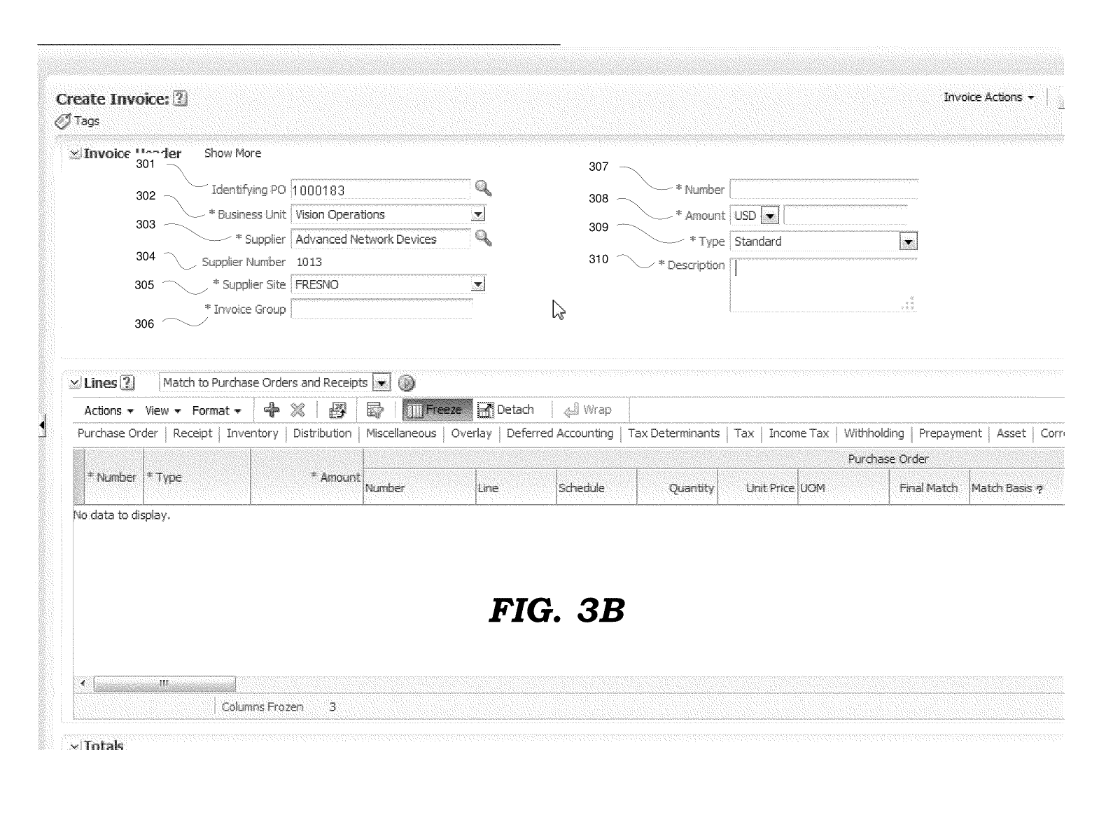

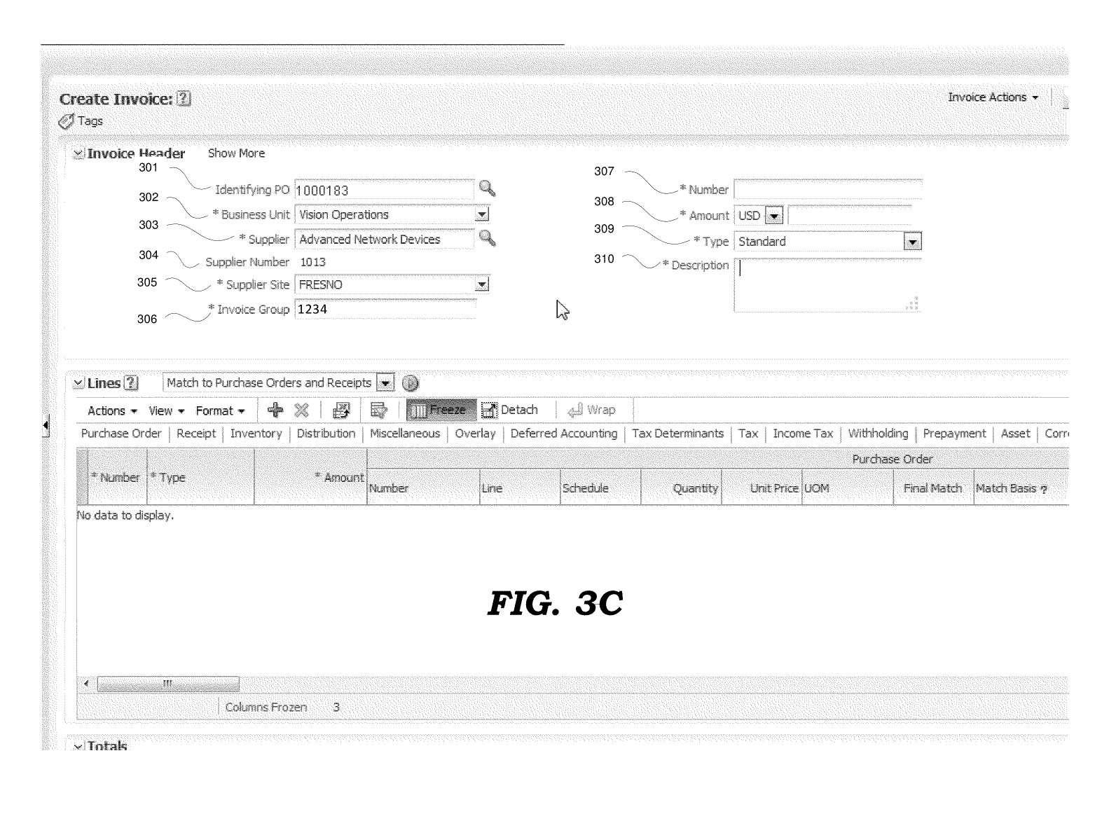

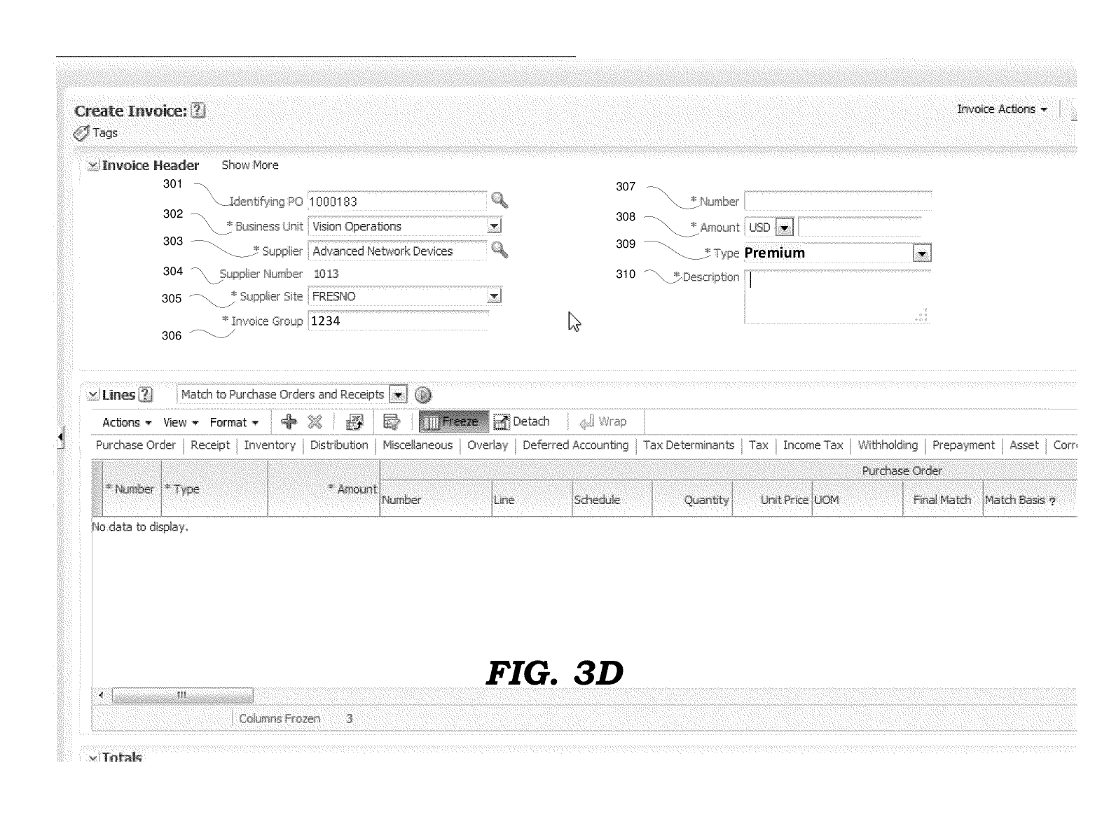

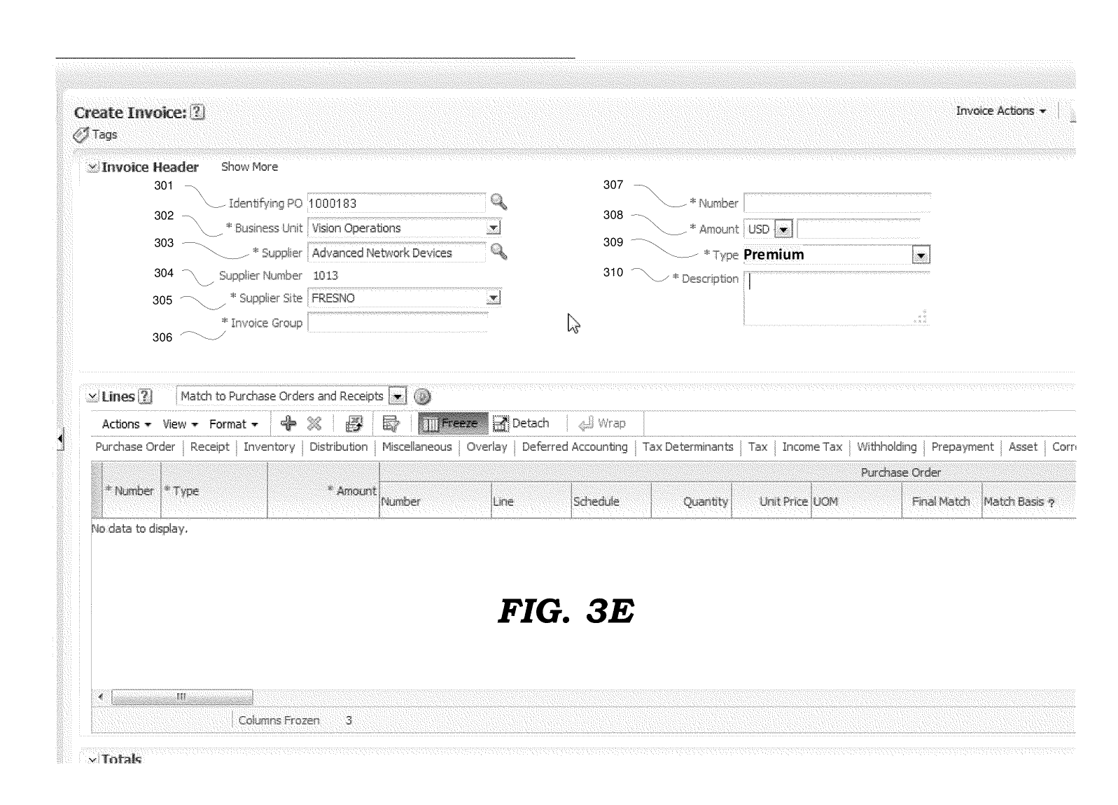

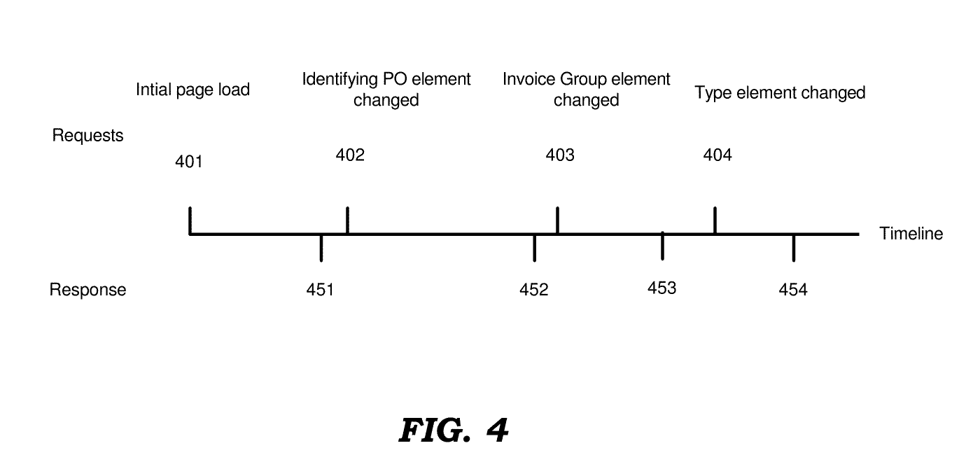

FIGS. 3A-3E together depict user interface screens at corresponding successive time instances, to illustrate an example problem experienced by a user. Each of the Figures shows fields 301-310. Entry of a value in a field may generate a corresponding request, and cause receipt of a response, which is displayed using partial page refresh capability. As described below, FIGS. 3A-3E depicts such sequence of requests and responses, and FIG. 4 shows the requests and responses over a timeline.

Request 401 is sent by browser 110 for initial display of a web page (of step 210). FIG. 3A depicts the corresponding initial web page displayed by browser 110 after receiving response 451.

User is assumed to have entered data into ‘Identifying PO’ field 301 (of FIG. 3A) and on tab-out, request 402 is sent by browser 110 to server system 140. The request is sent in view of a corresponding ‘event’ defined associated with the field 301 (in the HTML code for the web page), with the event defining execution of a script (also defined in the web page), which cause the request to be sent. It may thus be appreciated that when a user enters a value in some other field, without such associated ‘event’ defined, there is no (partial refresh) request sent to server system 140.

FIG. 3B shows the web page after receiving the corresponding response 452 (with the value of field 301 equaling that entered by the user). It may be observed that fields 302-305 are also shown displayed with values, due to the partial page refresh capability. It may be appreciated that server system 140 contains the logic to provide such additional values for corresponding fields (in the responses), that forms the basis for the partial page refresh.

The user is assumed to have entered a desired value (1234) in field 306, and request 403 is sent from browser 110 to server system 140. FIG. 3C depicts the web page displayed upon receipt of corresponding response 453.

The user assumed to change the value of ‘Type’ field 309 from ‘Standard’ to ‘Premium’ using a dropdown element, and request 404 is sent accordingly. FIG. 3D shows the web page at the time instance when Request 404 is sent but when response 454 is not yet received by browser 110. In FIG. 3D, ‘Invoice Group’ field at 306 is still shown with value of 1234.

FIG. 3E shows the web page when response 454 is received, where ‘Type’ field has value of ‘Premium’ but ‘Invoice Group’ field value at 306 has disappeared, which may be perceived to be an error.

The cause for such perception may be appreciated by understanding some features associated with partial page refresh capability. According to one feature, some fields/elements of a web page may be specified as being dependent on a base field in, for example, a JSFF (Java™ server faces fragment) file, that forms the basis for formulation of responses in server system 140. When value of a base field/element is changed, the corresponding dependant elements are automatically refreshed with their respective values through partial page refresh. As a part of such refreshing, browser 110 sends data in a request and receives data for dependant elements from sever system 140 as a background process, without interfering with the display and behavior of the rest of the existing page. As the request-response occurs in the background, user can continue interaction with web page.

It should be appreciated that a user may enter data in multiple elements in quick succession (depending on the page design), which causes generation of multiple requests in background. As the requests are transported and processed independently, the eventual display upon completion of processing of all the requests may depend on the sequence in which the requests and responses are interspersed on a time reference. For example, while FIG. 4 depicts that each request-response pair is completed before start of the next request, a user may potentially enter values corresponding to all four fields of events 401-404, and the responses may be received only after a user enters value for the last element (type element). As may be readily appreciated, the final values after processing of all the requests may not be consistently the same, and an error may be accordingly perceived/felt.

Aspects of the present disclosure enable at least such errors to be debugged as described below with examples. Broadly, browser 110 is implemented to generate a log of various information during the display of (and interactions with) a web page, and analysis tool 150 thereafter enables a user to view the changes due to each request-response pair. Accordingly, example embodiments of browser 110 and analysis tool 150 are described in detail below.

### 5. Browser

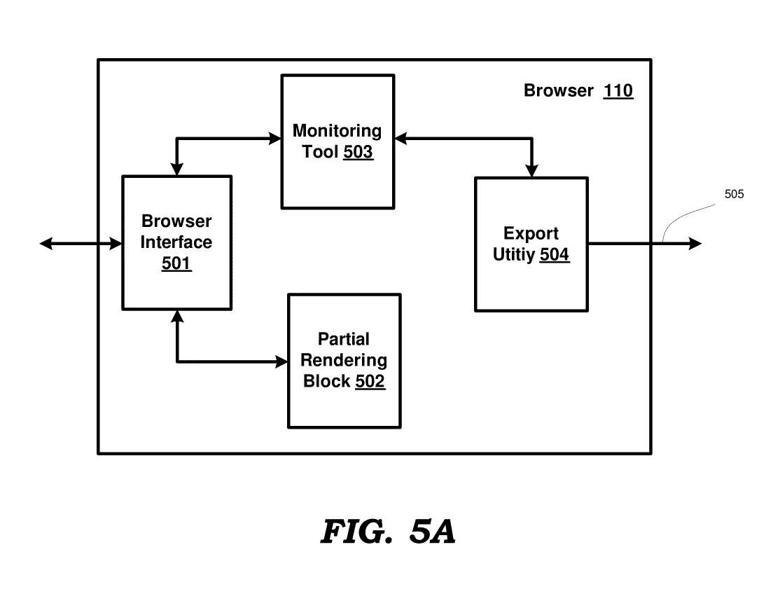

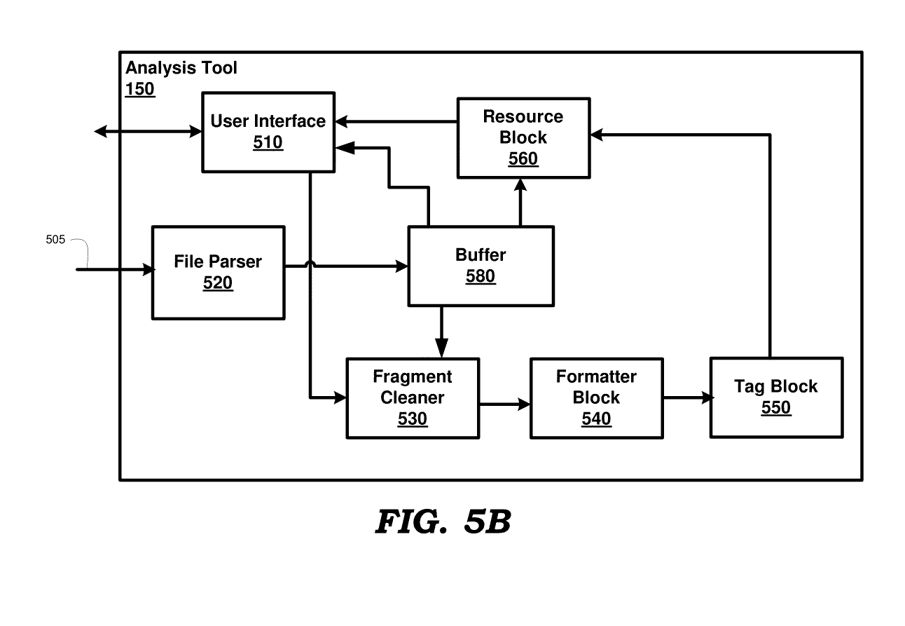

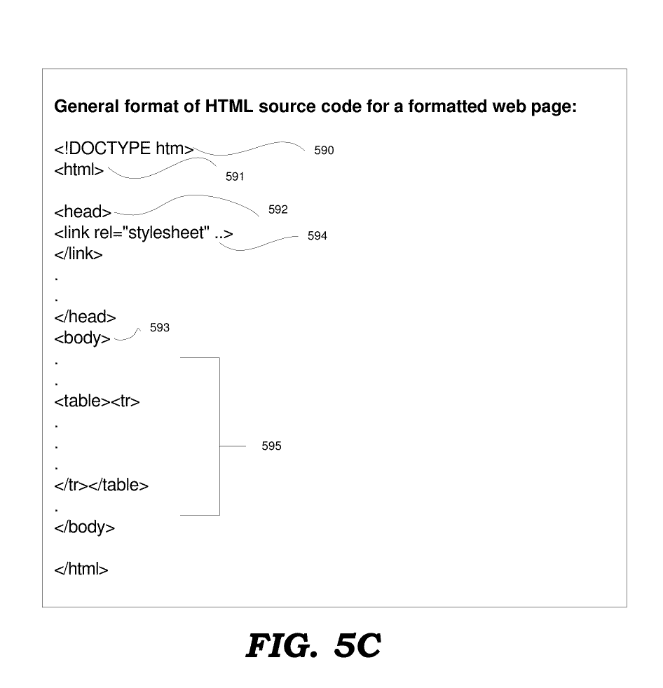

FIG. 5A is a block diagram illustrating the details of browser 110 in an embodiment. Browser 110 is shown containing browser interface 501, partial rendering block 502, monitoring tool 503 and export utility 504. Each block is described below in further detail.

Browser interface 501 displays web pages based on the corresponding source code (e.g., according to HTML) and enables a user to interact with elements of the displayed web page. Browser interface 501 is enhanced with partial page refresh capability due to the operation of partial rendering block 502.

Partial rendering block 502 is implemented as Ajax-engine in an embodiment. Broadly, some of the fields of a web page definition contain an associated event to be executed upon successful completion of entering of a value (into the field), and the event causes sending of the changed value to server system 140, and receipt of the corresponding response containing the field-values to be refreshed. Partial rendering block 502 causes the partial page refresh, refreshing only the constituent portions containing the fields, but leaving the remaining portions of the web page unchanged on the displayed screen.

Monitoring tool 503 monitors requests (both for the complete web page and the partial page refreshes) sent to, and response received from, server system 140. In an embodiment, browser 110 corresponds to Mozilla Firefox Browser and monitoring tool 503 is implemented as a Firebug plug-in to the browser.

Export utility 504 captures the information gathered by monitoring tool 503 into a log file. In an embodiment, export utility 504 is also implemented as plug-in to the browser 110. The plug-in may correspond to NetExport plug-in for capturing the information in a HTTP archive (HAR) file. The HAR file is sent on path 505 as input for analysis tool 150, and the manner in which the log may be processed is described below in further detail.

### 6. Analysis Tool

FIG. 5B is a block diagram illustrating the details of analysis tool 150 in an embodiment. Analysis tool 150 is shown containing user interface 510, file parser 520, fragment cleaner 530, formatter Block 540, tag Block 550, resource block 560 and buffer 580. Each block is described below in further detail.

File parser 520 examines the log received on path 505, and generates a parsed output that is convenient for operation of the remaining blocks. In general, the parsed output needs to be consistent with the input requirements of such remaining blocks. The parsed output is shown stored in buffer 580. Thus, based on examination of the complete web page in the received log file, file parser 520 identifies requests for resources such as style sheet, script, images, etc., and the corresponding URL (Uniform Resource Locator) is added into resource list inside the buffer 580. Buffer 580 may similarly store information identifying the requests for partial page refresh and corresponding responses.

User interface 510 provides a convenient user interface using which users may interact with analysis tool 150. User interface 510 receives from buffer 580 a list of requests for partial page refreshes, and enables a user to select a request of interest. User interface 510 thereafter interacts with fragment cleaner 530 to start formation of a corresponding formatted web page. As described below in further detail, fragment cleaner 530, formatter block 540, tag block and resource block 560 together operate to form such formatted web page, as a response to each selected request. The general format of a formatted web page is shown in FIG. 5C.

Fragment cleaner 530 retrieves response content corresponding to the selected request from buffer 580. Fragment cleaner 530 extracts the string inside <fragment> element. The extracted fragment string is not well formatted (does not represent a complete HTML string/text suitable to be displayed) and it may contain some tags such as escape data (CDATA) tag, which can be conveniently removed. Fragment cleaner 530 replaces/removes such escape data.

Formatter block 540 forms a formatted fragment (portion 595 of FIG. 5C) from the output of fragment cleaner 530 by addition of the missing tags. The missing tags may be determined and added according to an understanding of the HTML syntax. In an embodiment, formatter block 540 is implemented as Jtidy tool available as open source software.

Tag block 550 attaches HTML head (portion 592) and body (portion 593) tags to the formatted fragment string. Resource block 560 retrieves resource list from buffer 580 and adds style sheets (portion 594) to the HTML content. Further it replaces all resource references using relative paths with resource reference fully qualified by server system 140. Though not shown in the example illustrations, resource block 560 incorporates any required scripts (retrieved from buffer 580) that would be executed locally (while rendering the page) in causing display of corresponding fields included in the formatted partial web page. This completes the full and formatted HTML response (i.e., complete web page) for the selected request, which is enabled to be displayed on User Interface 510.

The manner, in which the full and formatted HTML generated by Analysis Tool 150 is used for debugging of errors in the web page, is described below with examples.

### 7. Example Illustration

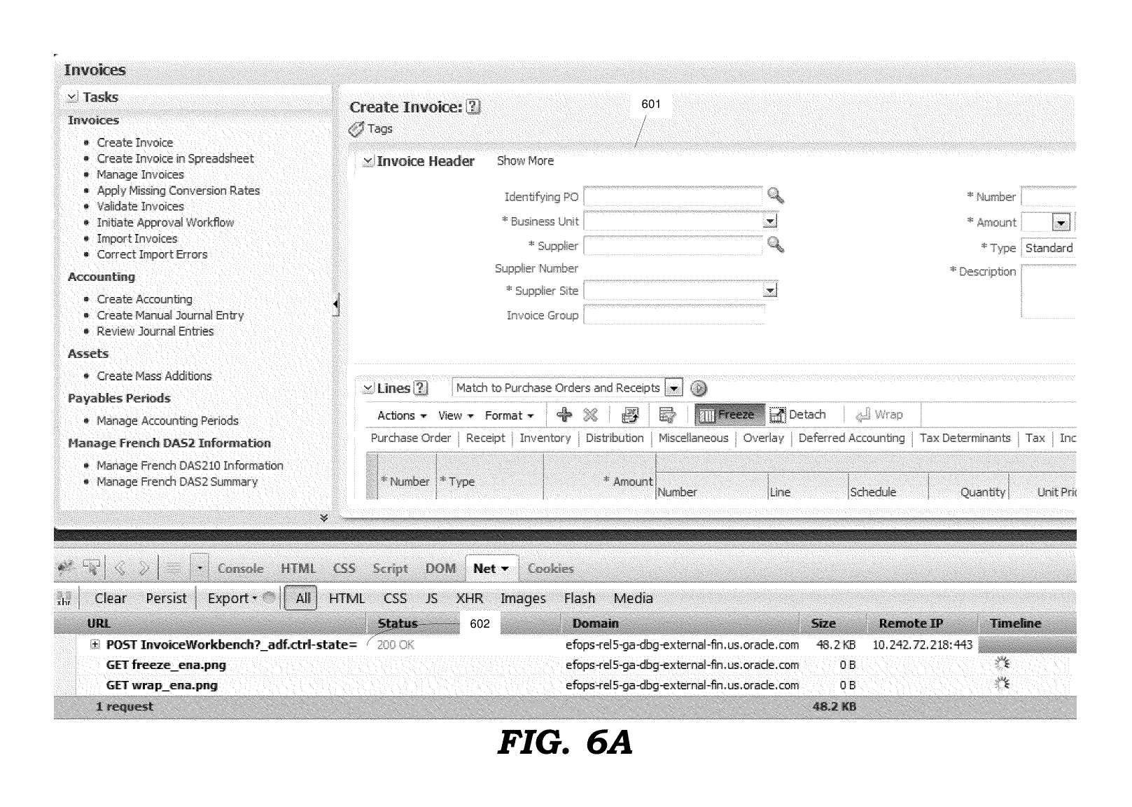

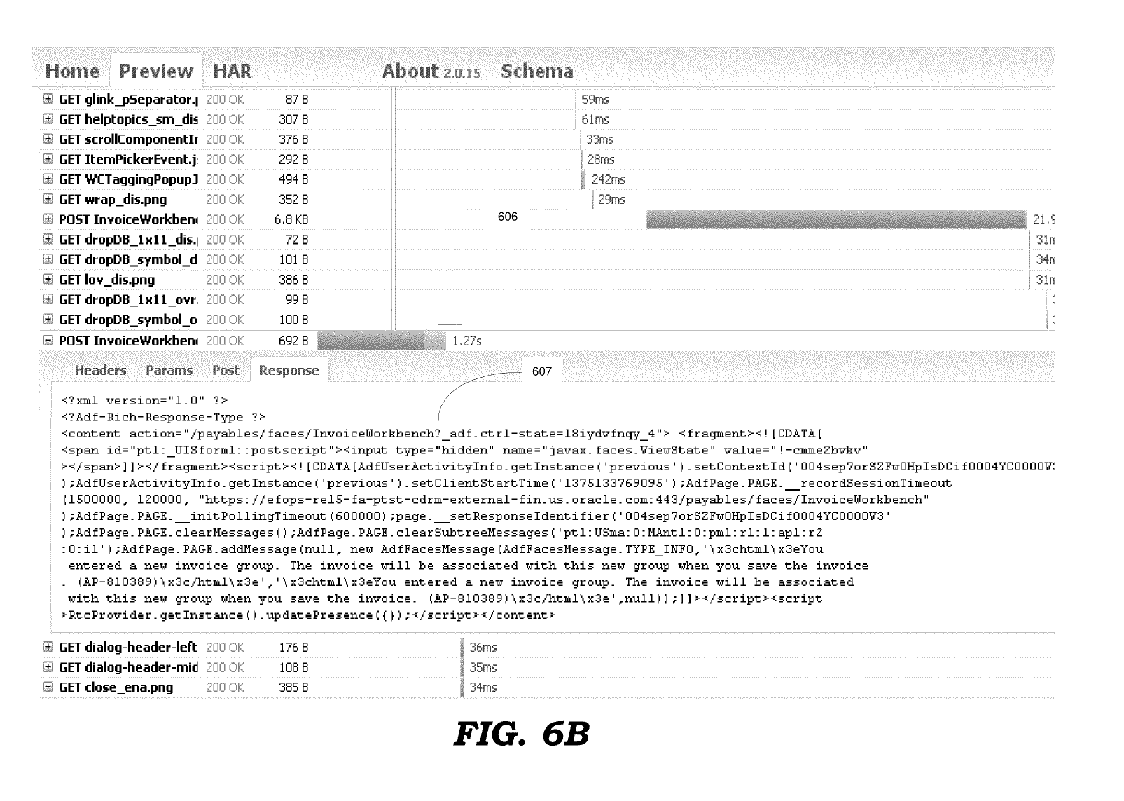

FIG. 6A depicts the web page interaction in portion 601, and the requests/responses (in portion 602) being captured by monitoring tool 503 and exported in the form of HAR file by export utility 504. FIG. 6B depicts an example user interface for examining the HAR file. Portion 606 lists the various requests sent from browser interface 501. When one of the requests is selected in portion 606, the corresponding response content is shown displayed in 607.

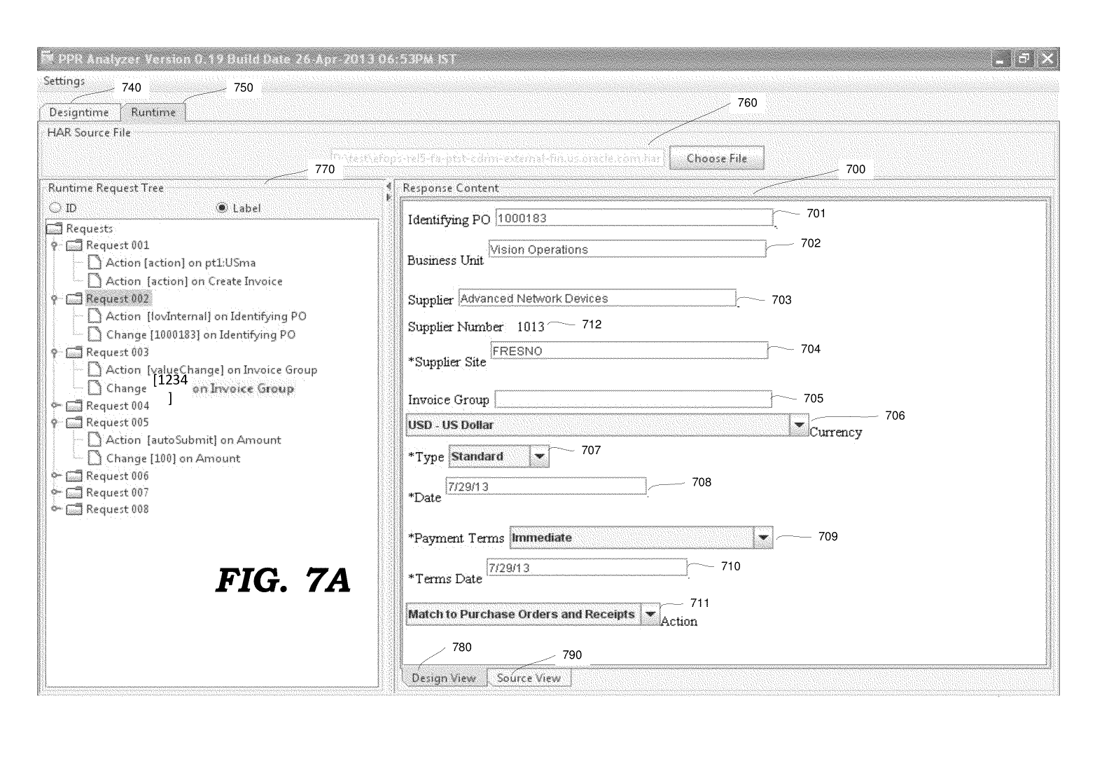

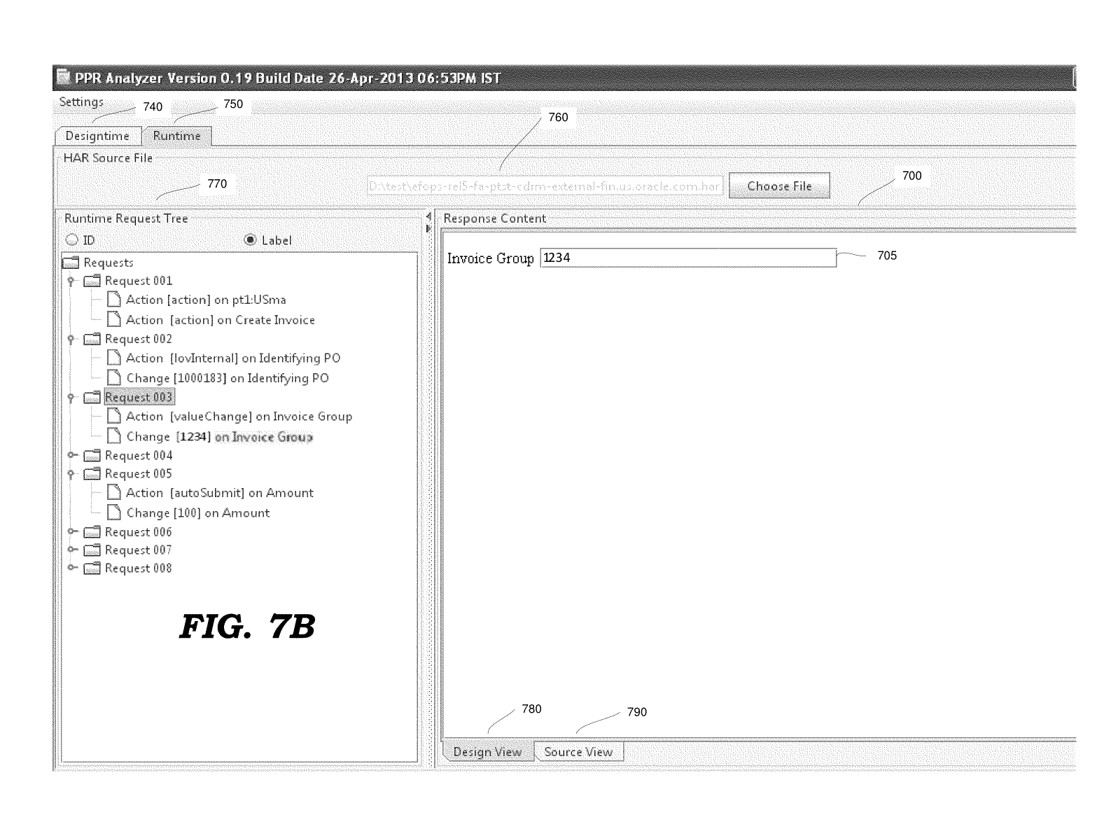

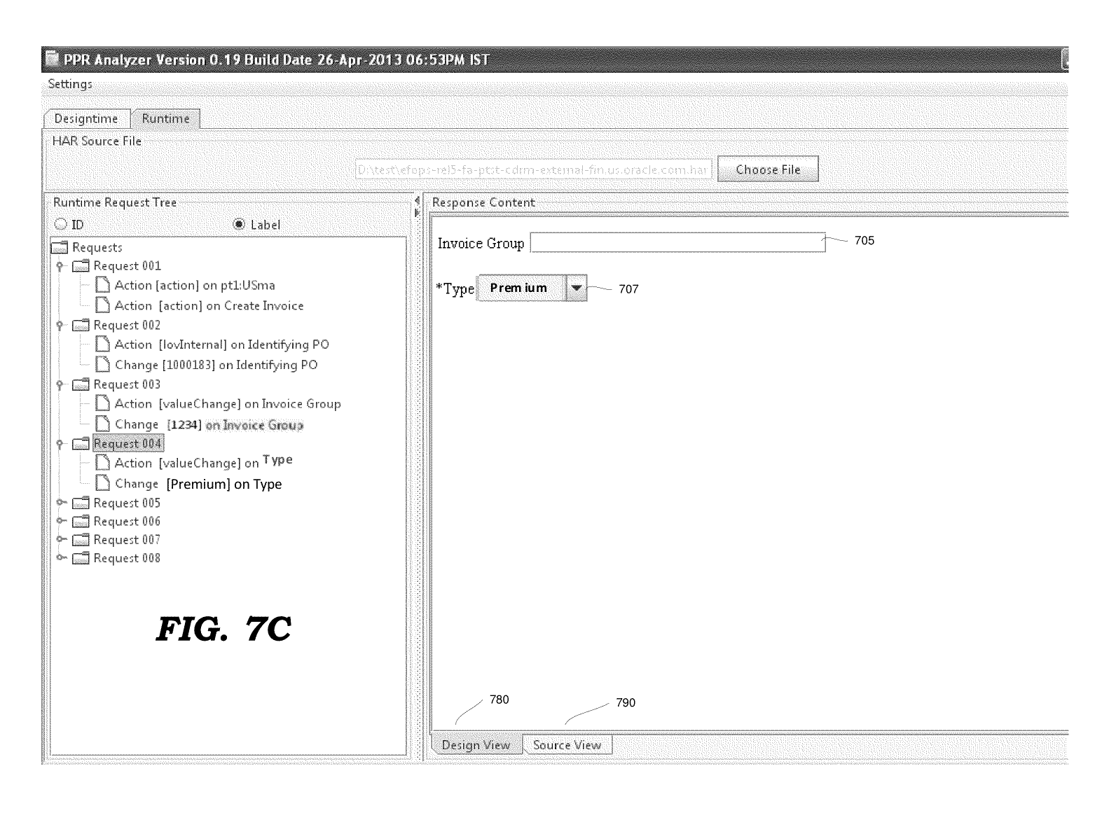

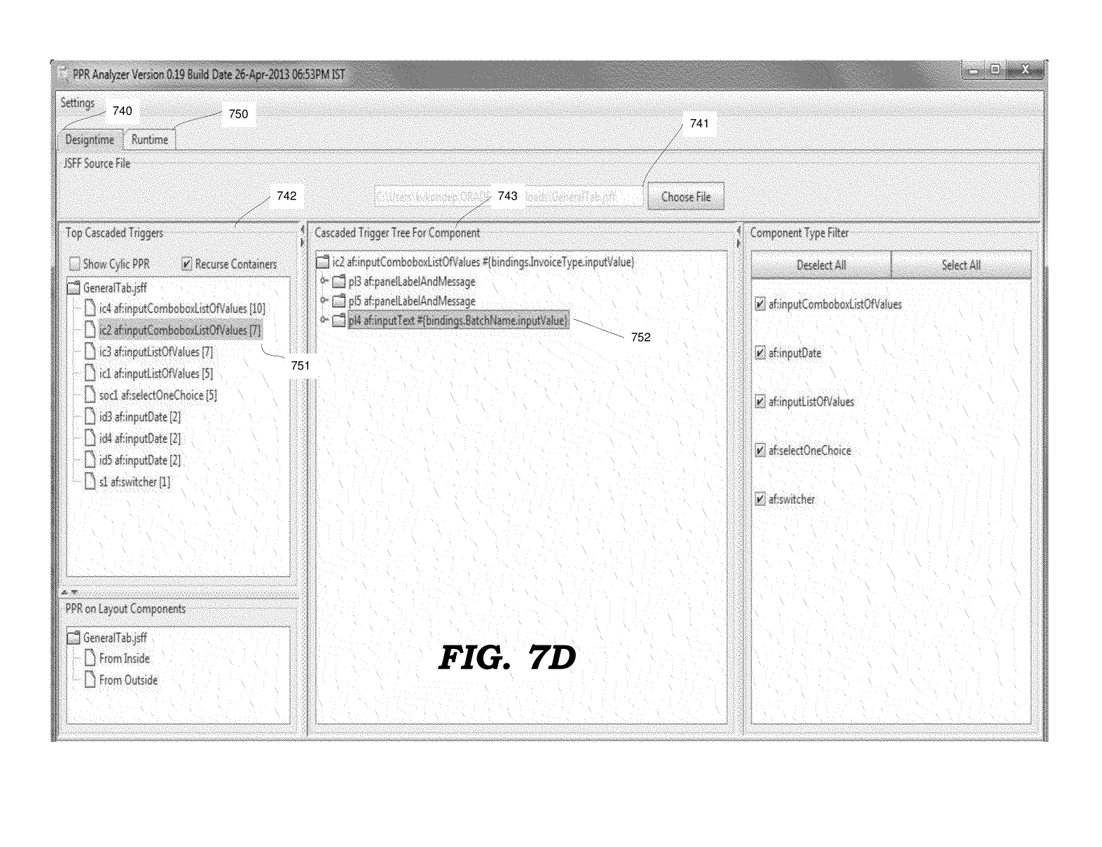

FIGS. 7A-7D shows graphical user interface of analysis tool 150, which is operative in two modes, runtime (at 750) mode and design-time (at 740) mode. Runtime mode helps to view formatted responses for requests. Design-time mode helps to understand design time dependency among elements of the web page.

FIGS. 7A-7C together depicts graphical user interface of analysis tool 150 in runtime mode in an example scenario. The example there illustrates examination of responses for successive partial page refresh requests, facilitating debugging of an example problem experienced by a user in FIGS. 3A-3E. HAR file is given as an input in ‘Choose file’ section 760. The Left panel (section 770) shows the list of requests captured inside the HAR file. There are two options to view the response—design view (at 780) and source view 790. In the design view, the rendered response is visible in section 700. In source view (at 790), html code for the response is displayed in section 700.

As shown in FIG. 7A, in section 770, request 2 is shown selected to view the corresponding response in section 700 of analysis tool 150. Request 2 corresponds to entering data into ‘Identifying PO’ field. The corresponding response is shown in portion 700, indicating that fields 701-712 (Business Unit, Supplier etc) were changed in the response, and each of the fields is shown with their corresponding changed values.

As shown in FIG. 7B, the user is shown to have selected Request 3 in section 770. Request 03 corresponds to entering value of 1234 into ‘Invoice Group’ field. Section 700 shows its response containing only ‘Invoice Group’ field at 705 with value of 1234, indicating that only that field was changed, and there are no other dependant fields for ‘Invoice Group’.

FIG. 7C shows the response to the Request 4, which corresponds to changing the value of ‘Type’ field. As shown in section 700, the response has two fields, ‘Type’ at 707 with value of ‘Premium’ and ‘Invoice Group’ field at 705 with blank value. On change of ‘Type’ field; ‘Invoice Group’ field is changed to blank from its value of 1234. This indicates that, change in the value of ‘Type’ field causes the change in the value of ‘Invoice Group’ field. It may thus be implied by a user that ‘Invoice Group’ is dependent on ‘Type’ field, explaining the reason for disappearance of the value of invoice group field.

In each of FIGS. 7A-7C, it may be observed that the changed elements are displayed graphically, implying that elements are displayed with corresponding graphic representation (as opposed to mere textual representation, for example, in the captured logs). For example, the Type field of FIG. 7A is shown as a dropdown graphical representation, and Date field is shown as a text box. In addition, the displays do not contain the elements not changed due to the corresponding responses. Thus, analysis tool 150 helps to better visualize responses for partial page requests and analyze any perceived errors.

Analysis tool 150 also helps to understand which all elements of the web page are refreshed during each request-response. As shown in FIG. 7C, for Request 4, analysis tool 150 shows elements refreshed due to the response for Request 4. Thus, a user can easily identify the specific elements that have changed (and the changed values) for each request/response. Accordingly, a user may have the requisite information while trying to debug various aspect of a user application causing displays on web pages with partial refresh capability.

In addition, analysis tool 150 may also facilitate users to identify if any unneeded (or unexpected) elements are refreshed on the page for a corresponding response. Such identification and consequent redesign of the web page, can reduce the network data transmitted (small sized response data) from server system 140 as well as reduce browser rendering time (due to lesser data to be processed and refreshed on the page by browser 110).

FIG. 7D shows the output of analysis tool 150 in design-time mode. To view dependencies among elements of a web page, its corresponding view file (presentation layer source code) is given as an input in section 741. In an embodiment, JSFF (Java™ server faces fragment) is given as input. The design time dependency among elements can be verified using this mode. Left panel (portion 742) shows ic2 element (section 751) is selected to view corresponding dependant elements. ic2 is an identifier for ‘Type’ field. Dependant elements are shown in right panel (portion 743) as p14 (section 752). p14 is an identifier for ‘Invoice Group’ field. Thus it can be confirmed that ‘Invoice Group’ field is designed to be dependent on ‘Type’ field (i.e., if Type field changes, the Invoice Group field is automatically refreshed).

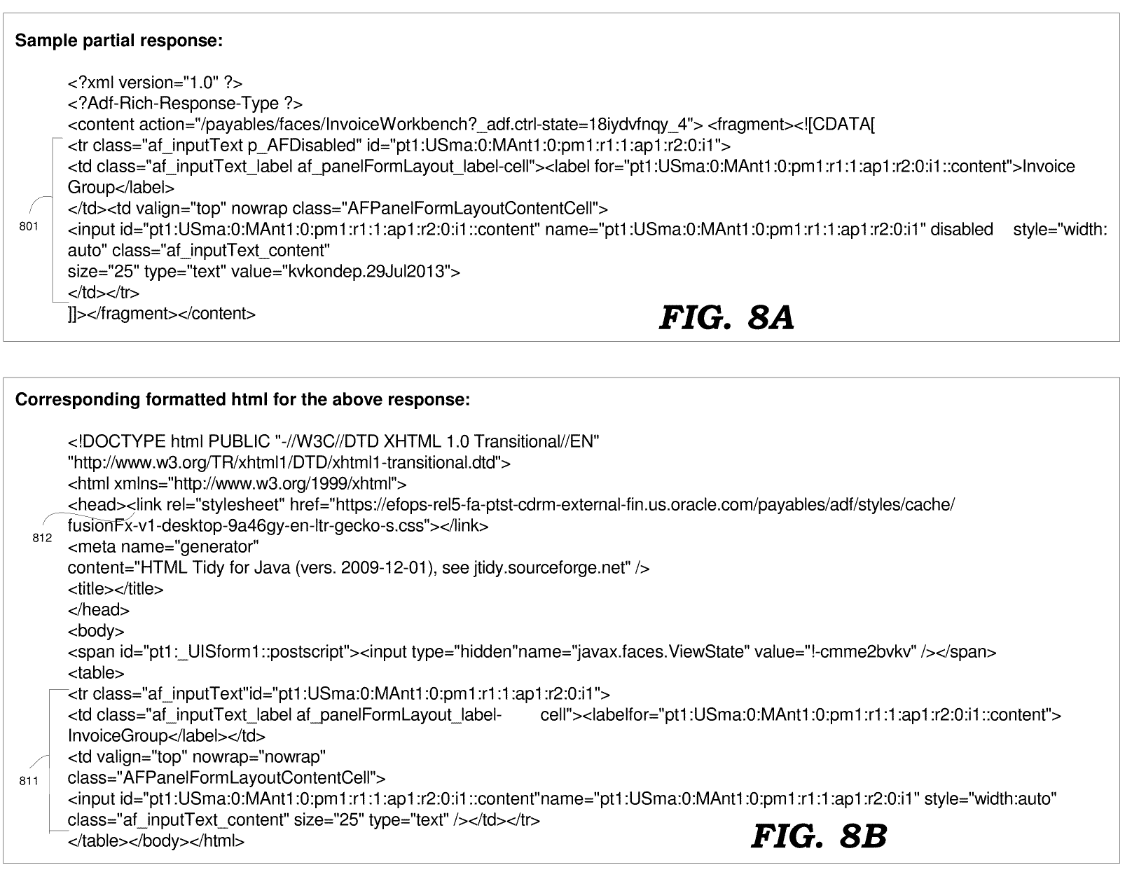

FIG. 8A depicts the sample unformatted response data received (from server system 140) for a partial page request. The response is a XML string containing incomplete HTML data. The string is said to be incomplete since the data is not amenable to rendered properly on a browser in view of some of the missing parts.

Analysis tool 150 formats the incomplete response from FIG. 8A and generates the formatted partial web page, the HTML code of which is shown in FIG. 8B. As may be readily observed, HTML fragment 801 is shown copied as 811, with a few formatting corrections described above. In addition, the remaining lines of FIG. 8B are also inserted by respective blocks of FIG. 5B, as described above.

As shown at 812, the reference to Style sheet is included in the formatted page content. Similarly, any client side logic which determines the appropriate values for corresponding fields, depending on variables such as user input or time of day for the fields/elements is also included in the formatted page, though not shown in FIG. 8B.

It should be further appreciated that the features described above can be implemented in various embodiments as a desired combination of one or more of hardware, software, and firmware. The description is continued with respect to an embodiment in which various features are operative when the software instructions described above are executed.

### 8. Digital Processing System

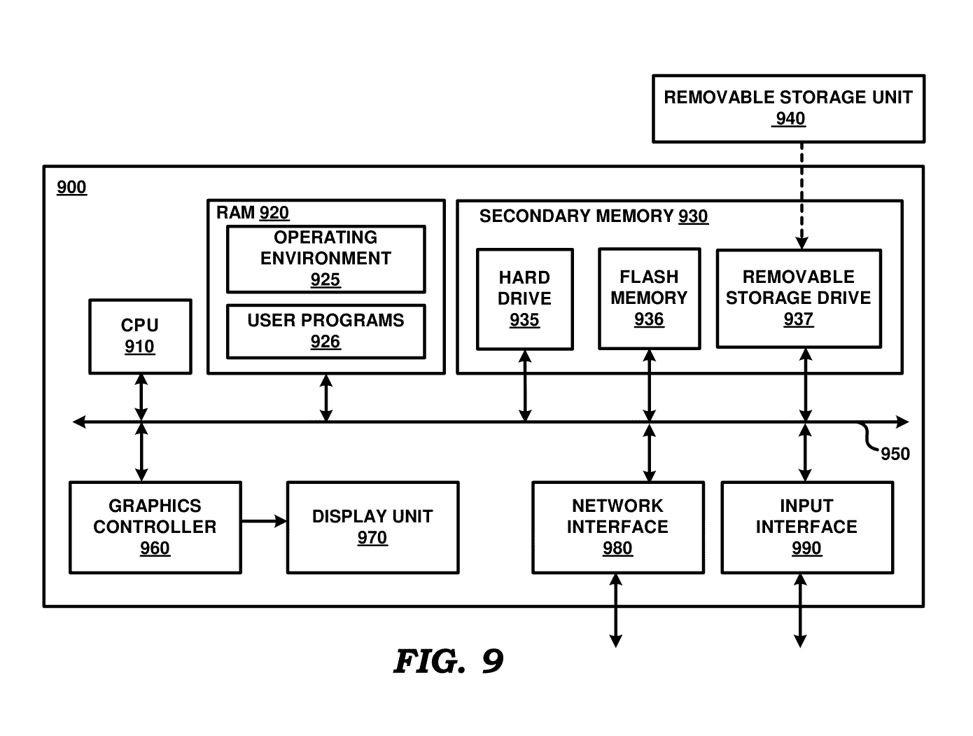

FIG. 9 is a block diagram illustrating the details of digital processing system 900 in which various aspects of the present disclosure are operative by execution of appropriate software instructions. Digital processing system 900 may correspond to client system 130.

Digital processing system 900 may contain one or more processors such as a central processing unit (CPU) 910, random access memory (RAM) 920, secondary memory 930, graphics controller 960, display unit 970, network interface 980, and input interface 990. All the components except display unit 970 may communicate with each other over communication path 950, which may contain several buses as is well known in the relevant arts. The components of FIG. 9 are described below in further detail.

CPU 910 may execute instructions stored in RAM 920 to provide several features of the present disclosure. CPU 910 may contain multiple processing units, with each processing unit potentially being designed for a specific task. Alternatively, CPU 910 may contain only a single general-purpose processing unit.

RAM 920 may receive instructions from secondary memory 930 using communication path 950. RAM 920 is shown currently containing software instructions constituting shared environment 925 and/or user programs 926 (such as client applications, Web browser, monitoring tool, export utility, analysis tool, etc.). Shared environment 925 includes operating systems, device drivers, virtual machines, etc., which provide a (common) run time environment for execution of user programs 926.

Graphics controller 960 generates display signals (e.g., in RGB format) to display unit 970 based on data/instructions received from CPU 910. Display unit 970 contains a display screen to display the images (e.g., those in FIGS. 3A-3E, 6A-6B and 7A-7D) defined by the display signals. Input interface 990 may correspond to a keyboard and a pointing device (e.g., touch-pad, mouse) and may be used to provide inputs. Network interface 980 provides connectivity to a network (e.g., using Internet Protocol), and may be used to communicate with other systems (such as those shown in FIG. 1) connected to the network.

Secondary memory 930 may contain hard drive 935, flash memory 936, and removable storage drive 937. Secondary memory 930 may store the data software instructions (e.g., for performing the actions noted above with respect to FIG. 2), which enable digital processing system 900 to provide several features in accordance with the present disclosure.

Some or all of the data and instructions may be provided on removable storage unit 940, and the data and instructions may be read and provided by removable storage drive 937 to CPU 910. Floppy drive, magnetic tape drive, CD-ROM drive, DVD Drive, Flash memory, removable memory chip (PCMCIA Card, EEPROM) are examples of such removable storage drive 937.

Removable storage unit 940 may be implemented using medium and storage format compatible with removable storage drive 937 such that removable storage drive 937 can read the data and instructions. Thus, removable storage unit 940 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 940 or hard disk installed in hard drive 935. These computer program products are means for providing software to digital processing system 900. CPU 910 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 930. Volatile media includes dynamic memory, such as RAM 920. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 950. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

### 9. CONCLUSION

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

What is claimed is:

1. A method of facilitating debugging of errors when displaying web pages with partial page refresh capability, said method being implemented in a client system, said method comprising:
receiving a source code of a complete web page containing a plurality of elements;
capturing in a log, a set of definitions present in said source code;
displaying said complete web page based on said source code;
monitoring a set of requests and a set of corresponding responses with respect to said displayed web page, wherein each of said set of requests and the corresponding response of said set of responses together are designed to cause partial refresh of said displayed web page;
adding details of said set of requests and said set of responses to said log;
receiving selection of a first request of said set of requests;
constructing from said log and said set of definitions, a formatted partial web page containing a set of elements of said plurality of elements with changes due to the response corresponding to said first request, wherein said set of elements and changes are determined by examining said log, said formatted partial web page being designed to graphically represent said set of elements based on said set of definitions; and
displaying said formatted partial web page, with said set of elements being displayed graphically.

2. The method of claim 1, wherein said complete web page comprises a second set of elements of said plurality of elements, wherein said second set of elements are not changed due to said first request,
said formatted partial web page not including said second set of elements.

3. The method of claim 2, wherein said the response corresponding to said first request contains a set of changed values, each changed value corresponding to an element of said set of elements,
wherein said formatted partial web page is designed to display the changed value of each of said set of elements.

4. The method of claim 3, wherein said set of definitions includes a client side logic for a first element of said set of elements,
said constructing including said client side logic in said formatted partial web page for said first element.

5. The method of claim 4, wherein said source code is in the form of Hypertext Markup Language (HTML) and said client side logic is in the form of a client side script.

6. The method of claim 3, wherein said set of definitions further comprises a style sheet of said complete web page such that formatting specified by said style sheet is used by said constructing for specifying formatting for at least some of said set of elements.

7. The method of claim 1, wherein said displaying further displays dependencies among said set of elements, wherein a second element is displayed as being dependent on a third element if a change to the value of said third element causes a change to the value of said second element.

8. A non-transitory machine readable medium storing one or more sequences of instructions for causing a digital processing system to facilitate debugging of errors when displaying web pages with partial page refresh capability, wherein execution of said one or more sequences of instructions by one or more processors contained in said server system causes said digital processing system to perform the actions of:
receiving a source code of a complete web page containing a plurality of elements;
capturing in a log, a set of definitions present in said source code;
displaying said complete web page based on said source code;
monitoring a set of requests and a set of corresponding responses with respect to said displayed web page, wherein each of said set of requests and the corresponding response of said set of responses together are designed to cause partial refresh of said displayed web page;
adding details of said set of requests and said set of responses to said log;
receiving selection of a first request of said set of requests;
constructing from said log and said set of definitions, a formatted partial web page containing a set of elements of said plurality of elements with changes due to the response corresponding to said first request, wherein said set of elements and changes are determined by examining said log, said formatted partial web page being designed to graphically represent said set of elements based on said set of definitions; and
displaying said formatted partial web page, with said set of elements being displayed graphically.

9. The non-transitory machine readable medium of claim 8, wherein said complete web page comprises a second set of elements of said plurality of elements, wherein said second set of elements are not changed due to said first request,
said formatted partial web page not including said second set of elements.

10. The non-transitory machine readable medium of claim 9, wherein said the response corresponding to said first request contains a set of changed values, each changed value corresponding to an element of said set of elements,
wherein said formatted partial web page is designed to display the changed value of each of said set of elements.

11. The non-transitory machine readable medium of claim 10, wherein said set of definitions includes a client side logic for a first element of said set of elements,
said constructing including said client side logic in said formatted partial web page for said first element.

12. The non-transitory machine readable medium of claim 11, wherein said source code is in the form of Hypertext Markup Language (HTML) and said client side logic is in the form of a client side script.

13. The non-transitory machine readable medium of claim 10, wherein said set of definitions further comprises a style sheet of said complete web page such that formatting specified by said style sheet is used by said constructing for specifying formatting for at least some of said set of elements.

14. The non-transitory machine readable medium of claim 8, wherein said displaying further displays dependencies among said set of elements, wherein a second element is displayed as being dependent on a third element if a change to the value of said third element causes a change to the value of said second element.

15. A digital processing for facilitating debugging of errors when displaying web pages with partial page refresh capability, said digital processing system comprising:
a memory to store instructions;
a processor to retrieve said instructions from said memory and execute the retrieved instructions, wherein execution of said instructions by said processor causes said digital processing system to perform the actions of:
receiving a source code of a complete web page containing a plurality of elements;
capturing in a log, a set of definitions present in said source code;
displaying said complete web page based on said source code;
monitoring a set of requests and a set of corresponding responses with respect to said displayed web page, wherein each of said set of requests and the corresponding response of said set of responses together are designed to cause partial refresh of said displayed web page;
adding details of said set of requests and said set of responses to said log;
receiving selection of a first request of said set of requests;
constructing from said log and said set of definitions, a formatted partial web page containing a set of elements of said plurality of elements with changes due to the response corresponding to said first request, wherein said set of elements and changes are determined by examining said log, said formatted partial web page being designed to graphically represent said set of elements based on said set of definitions; and
displaying said formatted partial web page, with said set of elements being displayed graphically.

16. The digital processing system of claim 15, wherein said complete web page comprises a second set of elements of said plurality of elements, wherein said second set of elements are not changed due to said first request,
said formatted partial web page not including said second set of elements.

17. The digital processing system of claim 16, wherein said the response corresponding to said first request contains a set of changed values, each changed value corresponding to an element of said set of elements,
wherein said formatted partial web page is designed to display the changed value of each of said set of elements.

18. The digital processing system of claim 17, wherein said set of definitions includes a client side logic for a first element of said set of elements,
said constructing including said client side logic in said formatted partial web page for said first element.

19. The digital processing system of claim 18, wherein said source code is in the form of Hypertext Markup Language (HTML) and said client side logic is in the form of a client side script.

20. The digital processing system of claim 17, wherein said set of definitions further comprises a style sheet of said complete web page such that formatting specified by said style sheet is used by said constructing for specifying formatting for at least some of said set of elements.
